(19) United States
(12) Patent Application Publication
(10) Pub. No.: US 2020/0231161 A1
(43) Pub. Date: Jul. 23, 2020

(54) METHOD AND APPARATUS FOR CONTROLLING VEHICLE STABILITY

(71) Applicants: HYUNDAI MOTOR COMPANY, Seoul (KR); KIA MOTORS CORPORATION, Seoul (KR)

(72) Inventor: Gyeong Seop Gim, Hwaseong-si (KR)

(21) Appl. No.: 16/416,657

(22) Filed: May 20, 2019

(30) Foreign Application Priority Data
Jan. 23, 2019 (KR) 10-2019-0008438

(51) Int. Cl. B60W 30/18; B60W 10/20; B60K 28/16; B60W 30/045; B60W 40/06; B60W 50/00; B60W 50/12

(52) U.S. Cl. CPC B60W 30/18172; B60W 10/20; B60K 28/16; B60W 30/045; B60W 2550/14; B60W 50/0098; B60W 50/12; B60W 2520/266; B60W 2520/28; B60W 40/06

(57) ABSTRACT

An apparatus for controlling stability of a vehicle may include a controller configured to determine whether the vehicle skids or not during linear driving at a predetermined speed or more, and when skidding is determined to occur, to perform a counter steering operation to drive a steering motor in a direction to offset the skidding.

### CROSS REFERENCE TO RELATED APPLICATION

The present application claims the benefit of priority to Korean Patent Application No. 10-2019-0008438, filed on Jan. 23, 2019 with the Korean Intellectual Property Office, the entire contents of which are incorporated herein by reference.

### TECHNICAL FIELD

The present disclosure relates to method and apparatus for maintaining and controlling stability of a vehicle during skidding using a steering motor.

### BACKGROUND

Generally, if during high-performance driving of a vehicle, only one of the wheels passes through a water puddle during or after a rainstorm, the vehicle may skid due to a loss of traction between the left and right wheels even if a driver does not perform a steering operation.

If the vehicle is suddenly braked upon skidding on a slippery road, the loss of traction between the left and right wheels becomes larger, resulting in a further increase in the amount of skidding, leading to a serious accident.

In the case of such an abnormal behavior of a vehicle, a vehicle stability control device is applied to stably hold the stability of the vehicle, and an electronic stability control (ESC) system is typically used.

However, in the case of the ESC system, since the price is relatively high, the material cost is excessively increased when applied to a vehicle, which causes the cost of the vehicle to rise.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and one objective of the present disclosure is to provide a method and apparatus for maintaining and controlling a vehicle's stability during skidding using a steering motor.

In order to achieve the above objective, according to one aspect of the present disclosure, a method of controlling stability of a vehicle using a controller may include steps of determining whether a vehicle skids or not during linear driving at a predetermined speed or more, and when skidding is determined to occur, performing a counter steering operation to drive a steering motor in a direction to offset skidding.

The controller may determine a skidding direction and whether skidding occurs or not, using parameters such as lateral acceleration, a steering angle, and left and right wheel speeds.

The controller may determine an occurrence of the skidding when the lateral acceleration exceeds a predetermined value, the steering angle is within a predetermined range relative to a neutral position of the steering angle, and a difference of the left and right wheel speeds exceeds a predetermined value.

The counter steering operation may be performed by setting a target steering angle for the lateral acceleration of the vehicle upon an occurrence of the skidding, and driving the steering motor according to the target steering angle.

The target steering angle may be proportional to the lateral acceleration.

The method may further include reducing an output of an engine when the skidding is determined to occur.

In another aspect of the present disclosure, an apparatus for controlling stability of vehicle may include a controller configured to determine whether a vehicle skids or not during linear driving at a predetermined speed or more, and to, when skidding is determined to occur, perform a counter steering operation to drive a steering motor in a direction to offset skidding.

The controller may determine a skidding direction and whether skidding occurs or not, using a lateral acceleration signal provided by a lateral acceleration sensor, a steering angle signal of a steering wheel provided by a steering angle sensor, and a left and right wheel speed signal provided by a left and right wheel speed sensor.

The controller may determine an occurrence of the skidding when the lateral acceleration exceeds a predetermined value, the steering angle is within a predetermined range relative to a neutral position of the steering angle, and a difference between the left and right wheel speeds exceeds a predetermined value.

The counter steering operation may be performed by setting a target steering angle for the lateral acceleration of the vehicle in response to the skidding, and driving the steering motor according to the target steering angle.

The target steering angle may be proportional to the lateral acceleration.

The controller may be further configured to reduce an output of an engine when the skidding is determined to occur.

According to the present disclosure, the steering motor is driven to perform the counter steering control to offset skidding when a vehicle skids in a high-speed linear driving state, thereby stably maintaining the vehicle's stability and improving the vehicle's steering stability, and thus preventing the risk of an accident caused by vehicle skidding.

### BRIEF DESCRIPTION OF THE DRAWINGS

The above and other objects, features and advantages of the present disclosure will be more clearly understood from the following detailed description when taken in conjunction with the accompanying drawings, in which:

FIG. 1 is an illustrative view showing driving routes according to whether a vehicle stability control of the present disclosure is applied or not;

FIG. 2 is a block diagram showing an illustrative system constituting a vehicle stability control apparatus according to an exemplary embodiment of the present disclosure;

FIG. 3 is a flowchart illustratively showing a procedure of a vehicle stability control method according to an exemplary embodiment of the present disclosure; and

FIG. 4 is a conceptual view illustrating the relationship between a target steering angle and lateral acceleration upon an occurrence of skidding.

It is to be understood that the appended drawings are not necessarily drawn to scale, and are presenting a somewhat simplified representation of various features illustrative of the basic principles of the disclosure. The specific design features of the present disclosure as disclosed herein, including, for example, specific dimensions, orientations, locations, and shapes will be determined in part by the particularly intended application and use environment.

### DETAILED DESCRIPTION

Hereinbelow, preferred exemplary embodiments of the present disclosure will be described in detail with reference to the accompanying drawings.

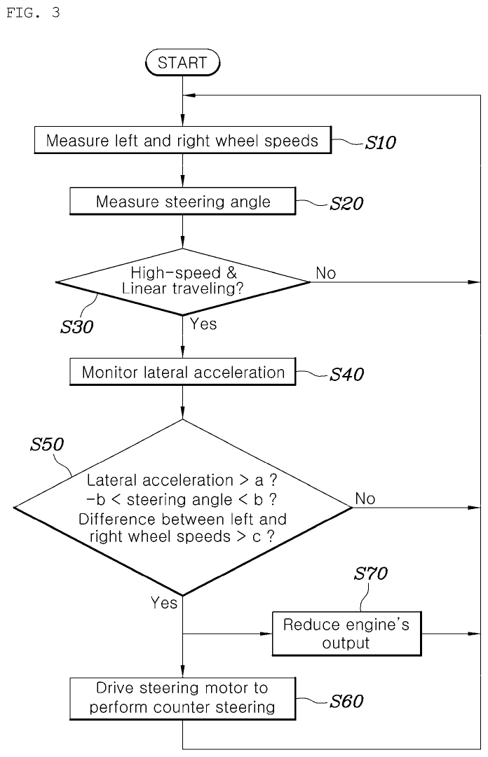

Referring to FIG. 2, an apparatus for controlling a vehicle's stability according to an exemplary embodiment of the present disclosure includes a controller CLR, which determines whether a vehicle skids or not during linear driving at a predetermined speed or more, and when skidding is determined to occur, performs a counter steering operation to drive a steering motor in a direction to offset the skidding.

The controller CLR of the apparatus according to an exemplary embodiment of the present disclosure may be a processor (e.g., computer, microprocessor, CPU, ASIC, circuitry, etc.). The controller may be implemented through a non-transitory memory configured to store data with respect to algorithms configured to control operations of various components in the vehicle or software instructions reproducing the algorithms, and a processor configured to perform the operations described hereinafter by using the data stored in the memory. Herein, the memory and the processor may be implemented as separate semiconductor circuits. Alternatively, the memory and the processor may be implemented as a single integrated semiconductor circuit. The processor may embody one or more processor(s).

The controller CLR may determine a skidding direction as well as whether skidding occurs or not, using a lateral acceleration signal provided by a lateral acceleration sensor 1, a steering angle signal of a steering wheel provided by a steering angle sensor 3, and left and right wheel speed signals provided by left and right wheel speed sensors 5 and 7.

For the vehicle stability control, the controller CLR may be provided with a lateral acceleration signal, a steering angle signal, and a wheel speed signal, which are detected by corresponding sensors.

For example, a lateral acceleration sensor 1 is provided to detect the lateral acceleration and send a detected lateral acceleration signal to the controller CLR.

Further, a steering angle sensor 3 is provided to a steering shaft to detect a steering angle of a steering wheel and send a detected steering angle signal to the controller CLR.

In addition, left and right wheel speed sensors 5 and 7 are provided to left and right wheels to detect respective wheel speeds and send detected wheel speed signals to the controller CLR.

Then, the controller CLR determines a skidding direction as well as whether skidding occurs or not, using the detected signals from the corresponding sensors.

The steering motor offsetting skidding of a vehicle may be a steering motor assisting a driver's steering torque, wherein the steering motor is applied to an MDPS system or an SEW system.

In the meantime, a vehicle stability control method according to an exemplary embodiment of the present disclosure includes a skidding-determination step and a counter steering step.

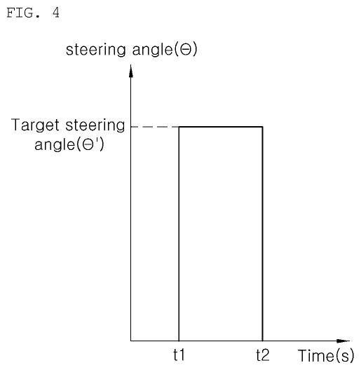

Referring to FIGS. 2 and 3, the skidding-determination step determines whether a vehicle skids or not in linear driving at a predetermined speed or more.

For example, linear driving at the predetermined speed or more may be determined using the steering angle and the left and right wheel speeds, and an occurrence of skidding and the skidding direction may be determined using the lateral acceleration, the steering angle, and the left and right wheel speeds.

Specifically, the linear driving of a vehicle at the predetermined speed or more may be determined when the respective left and right wheel speeds amount to predetermined values with a difference therebetween below a predetermined value, and the steering angle is within a predetermined range relative to a neutral position of the steering angle.

Particularly, the occurrence of skidding may be determined when the lateral acceleration exceeds a predetermined value, the steering angle is within a predetermined range relative to a neutral position of the steering angle, and the difference between the left and right wheel speeds exceeds a predetermined value.

Upon the occurrence of skidding, the skidding may be determined to occur in a direction toward a lower wheel speed. That is, when the left wheel speed is higher than the right wheel speed, the skidding may be determined to occur on the right side.

Further, in the counter steering step, upon skidding of a vehicle, the controller CLR performs a counter steering operation to control a steering motor to be driven in a direction to offset the skidding.

Moreover, upon skidding of the vehicle, the controller CLR may perform a control operation to reduce the output of an engine.

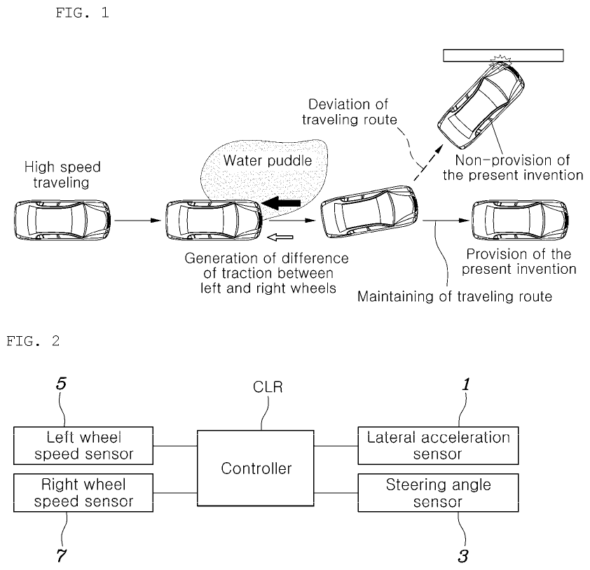

That is to say, when only the left wheel passes through the water puddle as shown in FIG. 1, the left wheel speed becomes rapidly decreased relative to the right wheel speed due to a difference of traction between the left and right wheels, so that the vehicle skids to the left side.

Then, when the skidding is determined to occur on the left side, the steering motor is driven to steer the steering wheel to the right side so that the vehicle is instantly steered to the right side so as to eliminate the skidding to the left side. Thus, the vehicle's stability is stably maintained to improve the vehicle's steering stability and prevent the risk of accident by skidding.

The counter steering operation may be performed by setting a target steering angle θ′ for the lateral acceleration of a vehicle upon the occurrence of skidding, and driving the steering motor according to the target steering angle θ′.

The target steering angle may be set so as to be proportional to the lateral acceleration.

That is, when skidding occurs, the lateral acceleration, which may be detected by the lateral acceleration sensor 1, increases.

For example, as the lateral acceleration detected through the lateral acceleration sensor 1 is larger, the vehicle also skids at a larger angle, so that the target steering angle is set in proportion to the lateral acceleration, and the steering motor is driven according to the set target steering angle to perform the counter steering operation.

Referring to FIG. 4, at time t1, a target steering angle is set according to the detected lateral acceleration at the time t1 when skidding of the vehicle occurs, and the steering motor is driven following the set target steering angle.

As the steering motor starts to operate, the skidding starts to be reduced and the lateral acceleration decreases. At the same time, the target steering angle is also reduced, and at time t2, the steering angle returns to a neutral position and skidding of the vehicle is completely eliminated.

Hereinafter, a procedure of vehicle stability control according to the present disclosure will be described with reference to FIG. 3.

In the traveling process of the vehicle, the left wheel speed, the right wheel speed, and the steering angle of the steering wheel are measured (S10 and S20).

After S20, it is determined whether the vehicle is running linearly at a high speed on the basis of the measured left and right wheel speeds and steering angle of the driving wheel (S30). For example, the linear driving of the vehicle at high speed may be determined when the steering angle is within a certain range (-b<steering angle<b) while the left wheel speed and the right wheel speed exceed a predetermined value, respectively.

As a result of the determination in S30, when it is determined that the vehicle is traveling linearly at a high speed, the lateral acceleration is monitored (S40).

After S40, when the difference between the left wheel speed and the right wheel speed exceeds c, while the lateral acceleration exceeds a and the steering angle is within a certain range (-b<steering angle<b) (S50), it is determined that skidding of the vehicle has occurred.

Then, counter steering control is performed by driving the steering motor so as to follow the target steering angle set in accordance with the lateral acceleration (S60).

In addition, by controlling the engine output so as to be reduced by a certain amount, the vehicle speed is reduced, so that skidding of the vehicle can be more stably attenuated (S70).

According to the present disclosure, the steering motor is driven to perform the counter steering control to offset skidding when a vehicle skids in a high-speed linear driving state, thereby stably maintaining the vehicle's stability and improving the vehicle's steering stability, and thus preventing the risk of accident caused by vehicle skidding.

The above description of the present disclosure is for illustrative purposes, and a person having ordinary skill in the art would appreciate that other specific modifications may be made without departing from the technical spirit or features of the present disclosure. Therefore, the above exemplary embodiments should be regarded as illustrative rather than limitative in all aspects. The scope of the disclosure is not to be limited by the detailed description set forth above, but by the accompanying claims of the present disclosure, and it should also be understood that all changes or modifications derived from the definitions and scope of the present disclosure, and their equivalents fall within the scope of the appended claims.

What is claimed is:

1. A method of controlling stability of a vehicle using a controller, the method comprising steps of:
determining whether a vehicle skids or not during linear driving at a predetermined speed or more, and
when skidding is determined to occur, performing a counter steering operation to drive a steering motor in a direction to offset the skidding.

2. The method of claim 1, wherein the controller determines a skidding direction and whether the skidding occurs or not, based on a lateral acceleration, a steering angle, and left and right wheel speeds of the vehicle.

3. The method of claim 2, wherein the controller determines an occurrence of the skidding when the lateral acceleration exceeds a predetermined value, the steering angle is within a predetermined range relative to a neutral position of the steering angle, and a difference between the left and right wheel speeds exceeds a predetermined value.

4. The method of claim 1, wherein the counter steering operation is performed by setting a target steering angle for a lateral acceleration of the vehicle upon an occurrence of the skidding, and driving the steering motor according to the target steering angle.

5. The method of claim 4, wherein the target steering angle is proportional to the lateral acceleration.

6. The method of claim 1, further comprising reducing an output of an engine when the skidding is determined to occur.

7. An apparatus for controlling stability of a vehicle, the apparatus comprising a controller configured to:
determine whether the vehicle skids or not during linear driving at a predetermined speed or more, and
when skidding is determined to occur, perform a counter steering operation to drive a steering motor in a direction to offset the skidding.

8. The apparatus of claim 7, wherein the controller determines a skidding direction and whether the skidding occurs or not, based on a lateral acceleration signal provided by a lateral acceleration sensor, a steering angle signal of a steering wheel provided by a steering angle sensor, and left and right wheel speed signals provided by left and right wheel speed sensors.

9. The apparatus of claim 8, wherein the controller determines an occurrence of the skidding when the lateral acceleration exceeds a predetermined value, the steering angle is within a predetermined range relative to a neutral position of the steering angle, and a difference between the left and right wheel speeds exceeds a predetermined value.

10. The apparatus of claim 8, wherein the counter steering operation is performed by setting a target steering angle for the lateral acceleration of the vehicle upon an occurrence of the skidding, and driving the steering motor according to the target steering angle.

11. The apparatus of claim 10, wherein the target steering angle is proportional to the lateral acceleration.

12. The apparatus of claim 7, wherein the controller is further configured to reduce an output of an engine when the skidding is determined to occur.
